(19) United States
(12) Patent Application Publication
(10) Pub. No.: US 2019/0383316 A1
(43) Pub. Date: Dec. 19, 2019

(54) SPACE-SAVING, COMPENSATING FASTENING SYSTEM

(71) Applicant: ILLINOIS TOOL WORKS INC., Glenview, IL (US)

(72) Inventors: Florian DÜLL, Rottingen (DE); Nikolas KEILHOLZ, Kolitzheim (DE)

(21) Appl. No.: 16/423,563

(22) Filed: May 28, 2019

(30) Foreign Application Priority Data
Jun. 15, 2018 (EP) 18178002.4

(51) Int. Cl. F16B 5/02; F16B 37/00

(52) U.S. Cl. CPC F16B 5/0233; F16B 37/00

(57) ABSTRACT

Tolerance-compensating fastening system (1) for fastening a first vehicle component (200) to a second vehicle component (300), has:
a compensating element (10) with a first external thread (11),
on the second vehicle component (300), an opening (30) with a first internal thread (31) for receiving the compensating element,
wherein the compensating element is premounted on the second vehicle component via the first external thread and the first internal thread, wherein, by turning, the compensating element has a longitudinal degree of freedom for compensating for a tolerance in the longitudinal direction (y) within a tolerance compensation range,
wherein the fastening system furthermore has
a screw (100) with a second external thread (102),
   wherein the compensating element has a longitudinal opening (20) with a second internal thread (22) for receiving the screw, wherein the second internal thread and the second external thread are designed to fit with one another.

### TECHNICAL FIELD

The invention relates generally to tolerance-compensating fastening systems.

### BACKGROUND

Prior-art document DE102015103491 discloses a tolerance-compensating fastening system containing a screw, a compensating element and a separate threaded part, which is configured to fit with the thread of the screw.

The inventors found it to be disadvantageous that, for a number of applications, the fastening system still requires too much installation space.

### SUMMARY

The object on which the invention is based was to improve on this disadvantage. The object is achieved by the invention, in particular as defined in the independent claims.

In particular, this object is achieved by a tolerance-compensating fastening system for fastening a first vehicle component to a second vehicle component, wherein the fastening system
has a compensating element with a first external thread,
has, on the second vehicle component, an opening with a first internal thread for receiving the compensating element, wherein the first internal thread and the first external thread are designed to fit with one another,

wherein the compensating element can be premounted or is premounted on the second vehicle component via the first external thread and the first internal thread, wherein, by turning, the compensating element has a longitudinal degree of freedom for compensating for a tolerance in the longitudinal direction within a tolerance compensation range,

wherein the fastening system furthermore
has a screw with a second external thread,

wherein the compensating element has a longitudinal opening with a second internal thread for receiving the screw, wherein the second internal thread and the second external thread are designed to fit with one another.

In particular, this object is achieved by the use
of a screw with a second external thread,
of a compensating element with a first external thread and with a longitudinal opening with a second internal thread for receiving the screw, wherein the second internal thread and the second external thread are designed to fit with one another, for the tolerance-compensating fastening of a first vehicle component to a second vehicle component,
by means of an opening on the second vehicle component, wherein the opening has a first internal thread for receiving the compensating element, wherein the first internal thread and the first external thread are designed to fit with one another, wherein the compensating element is premounted on the second vehicle component via the first external thread and the first internal thread, wherein the compensating element is moved in the longitudinal direction by rotation within the first tolerance compensation

This means that a small number of components provides a tolerance-compensating fastening system which can be used in a space-saving manner. This is achieved, in particular, by virtue of the second internal thread for the screw being integrated at least functionally, preferably structurally, in the compensating element.

The compensating element is preferably in the form of a sleeve. It preferably has a radially projecting stop surface on one end side, preferably on the end side which is directed toward the screw head in the mounted state.

It is preferably the case that, once the tolerance has been compensated for, the screw is tightened. It is preferably the case that the compensating element, which is premounted in the opening on the second vehicle component, is turned by virtue of the screw, which is at least partially screwed into the compensating element, being turned—this means that the compensation and tightening of the screw take place in one operation.

In the case of a further fastening system according to the invention, provision is made for the fastening system to have a stop on the second vehicle component and for the compensating element to be movable in the longitudinal direction up to the stop by turning within the tolerance compensation range.

This means that the compensating element itself can be oriented on the stop and orientation need not take place, for example, by the second vehicle component being held manually. It is preferably the case that first of all the compensating element is screwed into the second vehicle component up to the stop and then the screw is tightened; this preferably takes place in one operation by virtue of the screw, which is at least partially screwed into the compensating element, being turned.

In the case of a further fastening system according to the invention, provision is made for the fastening system to have a spring element which is designed, preferably at least in a sub-region of possible movement of the compensating element (10) within the tolerance compensation range, to simultaneously act on the compensating element and the stop.

This is less harmful to the stop surface, since a more gentle stopping action against the stop takes place. For example, one end of the element designed in the form of a helical spring establishes contact with the compensating element, and the other end establishes contact with the stop, at a certain point in time.

In the case of a further fastening system according to the invention, provision is made for the compensating element to bear against the stop if the tolerance in the longitudinal direction is compensated for.

In the case of a further fastening system according to the invention, provision is made for the second vehicle component to consist of at least two individual parts which are fastened to one another, wherein the opening with the first internal thread is arranged on another of these individual parts than the stop.

This makes it possible for the fastening system to compensate for a tolerance which results from the individual parts being fastened to give the second vehicle component, and therefore, despite a variable tolerance, the position of the first vehicle component relative to the stop is the same. As an alternative, the threaded opening and stop are provided on the same component, but the stop and the threaded opening are produced with a tolerance between them, e.g., on account of cold forming. This tolerance can likewise be compensated for by means of the fastening system.

In the case of a further fastening system according to the invention, provision is made for the compensating element to be designed to seal an opening on the stop against dirt and/or water spray by bearing against the stop.

This results in an additional function of the fastening system being achieved by straightforward means. It is preferably the case that i) the stop or ii) the compensating element has an elastomer component, e.g., an elastomer coating (e.g., TPE), which is designed to come into correspondingly sealing abutment i) against the compensating element or ii) against the stop by virtue of the compensating element being turned via its external thread.

In the case of a further fastening system according to the invention, provision is made for a second torque which is required for turning the screw in the compensating element to be higher than a first torque which is required for turning the compensating element in the opening on the second vehicle component.

This means that it is possible, by virtue of the screw being turned, first of all for the compensating element to be screwed into the opening of the second vehicle component up to the stop before, by means of the screw being turned further, the screw is screwed further into the compensating element and fixed. The first torque and the second torque relate preferably to a state with identical longitudinal forces acting on the threads, preferably in the non-fastened state. It is preferably the case that the compensating element has one or more frictional elements for bearing against the screw in order to increase the friction moment, and therefore the second torque, between the screw and compensating element. For example, the frictional element is one or a combination of the following: a separate clip, a molded-on or inserted, e.g., rubber-like, soft component, resilient tongues. It is preferably the case that the threads have one or more coatings or specially treated (e.g., polished) surfaces for influencing the (levels of) thread friction, in order for the relative torques required for turning purposes to be realized correspondingly.

In the case of a further fastening system according to the invention, provision is made for a relative thread deformation or relative thread misalignment to be present between the second internal thread and the second external thread.

This means that it is easily possible to increase the friction moment of the second internal-thread/external-thread pair and thus the second torque which is required for turning purposes. The thread deformation or thread misalignment is dimensioned such that the threads still fit with one another, i.e., such that the threads can still be screwed one inside the other, albeit with an increased friction moment.

In the case of a further fastening system according to the invention, provision is made for the first external thread and the first internal thread to be multi-start threads.

This achieves, for example, less harmful contact of the compensating element, for example, against the stop. As a result of the thread pitch being higher in the case of multi-start threads than for single threads with the same shape of flank, there is a reduction in the advancement force, when the torque remains the same, or, in the case of an advancement force remaining the same, a higher torque is required, for which reason the probability of damage to the components is smaller.

In the case of a further fastening system according to the invention, provision is made for the opening with the first internal thread to be fastened to the second vehicle component via an attachment element which is part of the fastening system.

This makes it possible for the first internal thread, e.g., in the form of a special multi-start thread, to be introduced separately into the attachment element, if it, for example, cannot be introduced directly into the second vehicle component, before it is then premounted on the second vehicle component, e.g., by means of latching elements, clip holders, one or more threads and/or screws. In addition, this can facilitate the premounting operation in that, for example, the first internal thread and the first external thread are already screwed to one another and only then are fastened to the second vehicle component quickly and easily via the attachment element, e.g., by latching means.

In the case of a further fastening system according to the invention, provision is made for the fastening system to have a spring element which is designed to act on the compensating element in the premounted state of the compensating element.

This creates more defined friction between the first external thread and the first internal thread, which is beneficial to the adjustment of the relative frictions between the first internal-thread/external-thread pair and the second internal-thread/external-thread pair. In addition, the risk of skewing is reduced. The spring element may be the same spring element which is designed to simultaneously act on the compensating element and the stop.

In the case of a further fastening system according to the invention, provision is made for the fastening system to have an extension element which is designed to extend the compensating element in the longitudinal direction.

This makes it possible to create different variants (variation of overall length in the longitudinal direction=variation of dimension to be adjusted). The extension element is, for example, a threaded sleeve which can be coupled to the compensating element in a rotationally fixed manner (e.g., via an end-side toothing formation).

The invention will now be demonstrated further, by way of example, with reference to drawings, in which:

### BRIEF DESCRIPTION OF THE DRAWINGS

FIGS. 1A-1C show a first embodiment of a device according to the invention, wherein FIG. 1A is an exploded illustration in a perspective oblique view, FIG. 1B illustrates a side view in the premounted state and FIG. 1C illustrates a side view in the definitively mounted state.

### DETAILED DESCRIPTION

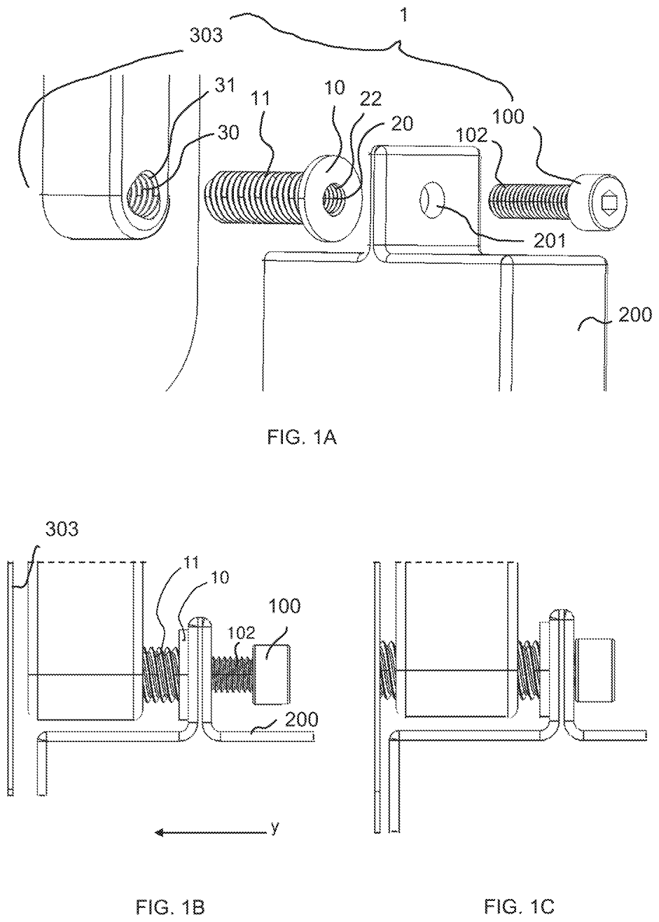

A more detailed description of FIGS. 1A-C follows hereinbelow. The configuration of the tolerance-compensating fastening system for fastening a first vehicle component 200 to a second vehicle component 300 is such that the fastening system 1
has a compensating element 10 with a first external thread 11,
has, on the second vehicle component 300, an opening 30 with a first internal thread 31 for receiving the compensating element 10, wherein the first internal thread 31 and the first external thread 11 are designed to fit with one another,

wherein the compensating element 10 can be premounted or is premounted on the second vehicle component 300 via the first external thread 11 and the first internal thread 31, wherein, by turning, the compensating element 10 has a longitudinal degree of freedom for compensating for a tolerance in the longitudinal direction y within a tolerance compensation range,

wherein the fastening system furthermore
has a screw 100 with a second external thread 102,

wherein the compensating element 10 has a longitudinal opening 20 with a second internal thread 22 for receiving the screw 100, wherein the second internal thread 22 and the second external thread 102 are designed to fit with one another.

Figures also show the use
of a screw 100 with a second external thread 102,
of a compensating element 10 with a first external thread 11 and with a longitudinal opening 20 with a second internal thread 22 for receiving the screw 100, wherein the second internal thread 22 and the second external thread 102 are designed to fit with one another,

for the tolerance-compensating fastening of a first vehicle component 200 to a second vehicle component 300,
by means of an opening 30 on the second vehicle component 300, wherein the opening 30 has a first internal thread 31 for receiving the compensating element 10, wherein the first internal thread 31 and the first external thread 11 are designed to fit with one another, wherein the compensating element 10 is premounted on the second vehicle component 300 via the first external thread 11 and the first internal thread 31, wherein the compensating element 10 is moved in the longitudinal direction y by rotation within the first tolerance compensation range and thus a compensation of a tolerance in the longitudinal direction y is obtained.

The compensating element here is in the form of a sleeve. It has a radially projecting stop surface on one end side, in this case on the end side which is directed toward the screw head in the mounted state. The configuration is such that the fastening system 1 has a stop 303 on the second vehicle component 300 and the compensating element 10 is movable in the longitudinal direction y up to the stop 303 by turning within the tolerance compensation range. The configuration is such that the compensating element 10 bears against the stop 303 if the tolerance in the longitudinal direction y is compensated for (FIG. 1C). The configuration is such that the second vehicle component 300 consists of at least two individual parts which are fastened to one another, wherein the opening 30 with the first internal thread 31 is arranged on another of these individual parts than the stop 303. The configuration is such that a first torque which is required for turning the screw 100 in the compensating element 10 is higher than a second torque which is required for turning the compensating element 10 in the opening 30 on the second vehicle component 300.

### LIST OF REFERENCE SIGNS

1 Fastening system
10 Compensating element
11 First external thread
20 Longitudinal opening
22 Second internal thread
30 Opening
31 First internal thread
100 Screw
102 Second external thread
200 First vehicle component
300 Second vehicle component
303 Stop
y In the longitudinal direction

What is claimed is:

1. A tolerance-compensating fastening system (1) for fastening a first vehicle component (200) to a second vehicle component (300), wherein the fastening system (1)
has a compensating element (10) with a first external thread (11),
has, on the second vehicle component (300), an opening (30) with a first internal thread (31) for receiving the compensating element (10), wherein the first internal thread (31) and the first external thread (11) are designed to fit with one another,
wherein the compensating element (10) can be premounted or is premounted on the second vehicle component (300) via the first external thread (11) and the first internal thread (31), wherein, by turning, the compensating element (10) has a longitudinal degree of freedom for compensating for a tolerance in the longitudinal direction (y) within a tolerance compensation range,
wherein the fastening system furthermore
has a screw (100) with a second external thread (102), characterized in that the compensating element (10) has a longitudinal opening (20) with a second internal thread (22) for receiving the screw (100), wherein the second internal thread (22) and the second external thread (102) are designed to fit with one another.

2. Fastening system (1) according to claim 1, wherein the fastening system (1) has a stop (303) on the second vehicle component (300) and wherein the compensating element (10) is movable in the longitudinal direction (y) up to the stop (303) by turning within the tolerance compensation range.

3. Fastening system (1) according to claim 2, wherein the fastening system (1) has a spring element which is designed to simultaneously act on the compensating element (10) and the stop (303).

4. Fastening system (1) according to claim 2, wherein the compensating element (10) bears against the stop (303) if the tolerance in the longitudinal direction (y) is compensated for.

5. Fastening system (1) according to claim 2, wherein the second vehicle component (300) consists of at least two individual parts which are fastened to one another, wherein the opening (30) with the first internal thread (31) is arranged on another of these individual parts than the stop (303).

6. Fastening system (1) according to claim 2, wherein the compensating element (10) is designed to seal an opening on the stop (303) against dirt and/or water spray by bearing against the stop (303).

7. Fastening system (1) according to claim 1, wherein a second torque which is required for turning the screw (100) in the compensating element (10) is higher than a first torque which is required for turning the compensating element (10) in the opening (30) on the second vehicle component (300).

8. Fastening system (1) according to claim 1, wherein a relative thread deformation or relative thread misalignment is present between the second internal thread (22) and the second external thread (102).

9. Fastening system (1) according to claim 1, wherein the first external thread (11) and the first internal thread (31) are multi-start threads.

10. Fastening system (1) according to claim 1, wherein the opening (30) with the first internal thread (31) is fastened to the second vehicle component via an attachment element which is part of the fastening system (1).

11. Fastening system (1) according to claim 1, wherein the fastening system (1) has a spring element which is designed to act on the compensating element (10) in the premounted state of the compensating element (10).

12. Fastening system (1) according to claim 1, wherein the fastening system (1) has an extension element which is designed to extend the compensating element (10) in the longitudinal direction (y).

13. (canceled)

14. A system, comprising:
a first vehicle component (200) fastened to a second vehicle component (300) with tolerance compensation, wherein the second vehicle component (330) has an opening (30) with a first internal thread (31);
a compensating element (10) for tolerance-compensating fastening of the first vehicle component (200) to the second vehicle component (300), the compensating element having a first external thread (11);
a screw (100) with a second external thread (102);
wherein the compensating element includes a longitudinal opening (20) with a second internal thread (22);
wherein the screw (10) is received within the longitudinal opening (20) such that the second internal thread (22) and the second external thread (102) are threadedly engaged;
wherein the compensating element (1) is received in the opening (30) such that the first internal thread (31) and the first external thread (11) are threadedly engaged;
wherein the compensating element (10) is premounted on the second vehicle component (300) via the first external thread (11) and the first internal thread (31);
wherein the compensating element (10) is movable in a longitudinal direction (y) by rotation within a first tolerance compensation range and thus a compensation of a tolerance in the longitudinal direction (y) is obtainable.
